(19) United States
(12) Patent Application Publication
(10) Pub. No.: US 2016/0028088 A1
(43) Pub. Date: Jan. 28, 2016

(54) Electrode Current Collector Shielding And Protection

(71) Applicant: Axion Power International, Inc., New Castle, PA (US)

(72) Inventors: Michael Romeo, Bessemer, PA (US); Andrew Holmes, New Castle, PA (US)

(73) Assignee: Axion Power International, Inc., New Castle, PA (US)

(21) Appl. No.: 14/338,717

(22) Filed: Jul. 23, 2014

(51) Int. Cl. H01M 4/66; H01M 4/1395; C09D 5/08; H01M 4/04; H01M 10/42; H01M 10/20

(52) U.S. Cl. CPC H01M 4/667; H01M 4/661; H01M 10/4235; H01M 10/20; C09D 5/08; H01M 4/0404; H01M 4/0419; H01M 4/1395; H01M 2220/20

(57) ABSTRACT

A corrosion-resistant conductive liquid coating for a current collector is described herein. The coating includes a mixture of carbon and wax. The wax can be selected from a paraffin wax, a microcrystalline wax, and mixtures and combinations thereof. The mixture can have a carbon loading of approximately 10 to 50 wt. %, based on total weight of the mixture. Methods for protecting a current collector from material degradation are also described herein.

### FIELD OF THE INVENTION

The present disclosure generally relates to materials and methods for protecting and shielding the current collector of electrodes found in batteries, such as lead carbon batteries.

### BACKGROUND

In the area of battery technology, lead carbon batteries offer an alternative to lead acid batteries and other battery types. Lead carbon batteries can provide a safer, stronger, more reliable, and longer lasting battery life for, inter alia, hybrid and electric vehicle technology and power technology. In particular, lead carbon battery performance is capable of remaining stable in excess of 100,000 miles, thereby eliminating much of the need, aggravation, and extra costs associated with having to undergo frequent battery replacement.

Lead carbon batteries also demonstrate an impressive 98% recyclability profile and carry significantly lower manufacturing costs when compared to other batteries. With regard to hybrid and electric vehicle technology, lead carbon batteries also provide greater fuel economy and fuel efficiency.

Referring now to physical and structural characteristics of batteries, the negative electrodes of lead acid batteries generally consist of simple sponge lead plates. By comparison, the negative electrodes of lead carbon batteries, such as those disclosed in U.S. Pat. No. 7,881,042; U.S. Pat. No. 7,998,616; U.S. Pat. No. 8,023,251; and U.S. Pat. No. 8,202,653, can comprise of five layer assemblies having a first carbon electrode, a corrosion barrier, a current collector, a second corrosion barrier, and a second carbon electrode. The disclosures of U.S. Pat. Nos. 7,881,042; 7,998,616; 8,023,251; and 8,202,653 are hereby incorporated by reference in its entireties.

Regarding the current collector of the negative electrode, one significant challenge relating to the technological development of lead carbon batteries involves the creation of an electrode shield that is capable of effectively and efficiently protecting said current collector from corrosion and other detrimental forms of material degradation.

One approach to protecting the current collector involves utilizing a graphite foil or a graphite sheet to protect the electrode. The graphite is typically impregnated with a substance to make graphite foil or graphite sheet acid-resistant. However, this graphite foil/graphite sheet approach is not without problems.

The first of these problems relates to electrode resistance. By surrounding the current collector (e.g., copper current collector) with a graphite packet, it becomes nearly impossible to evacuate all of the air from the packet that separates the graphite foil from the current collector. This layer of air detrimentally imparts a significant amount of contact resistance to the electrode assembly.

A second problem associated with the graphite foil/graphite sheet protection approach is that the void space between the current collector and the graphite foil protection shield provides a space for acid to enter the graphite packet and engage in copper attack, thereby damaging the negative electrode and battery as a whole.

In view of the foregoing, a need exists for novel and innovative technology capable of overcoming the above difficulties relating to protecting and shielding the current collector of electrodes found in, for example, lead carbon batteries. The present invention addresses these and other needs by providing materials and methods for protecting and shielding the current collector of lead carbon battery electrodes. The inventors have unexpectedly discovered that inventions of the present disclosure result in improved resistance of cells, a reduction in the thickness of the electrode, significant cost savings, and increased energy output, among others.

### SUMMARY

At least one embodiment of the present invention includes a corrosion-resistant conductive liquid coating for a current collector. The corrosion-resistant conductive liquid coating includes a mixture of carbon and wax. The wax can be selected from the group consisting of a paraffin wax, a microcrystalline wax, and mixtures and combinations thereof. The mixture of carbon and wax can have a carbon loading in a range of approximately 10 to 50 wt. %, based on a total weight of the mixture.

At least one embodiment of the present invention also includes a method for protecting a current collector from material degradation. The method includes applying a liquid coating onto an outer surface of a current collector, whereby the liquid coating includes a mixture of carbon and wax. The wax can be selected from the group consisting of a paraffin wax, a microcrystalline wax, and mixtures and combinations thereof. The mixture of carbon and wax can also have a carbon loading in a range of approximately 10 to 50 wt. %, based on a total weight of the mixture.

### BRIEF DESCRIPTION OF THE SEVERAL VIEWS OF THE DRAWINGS

The present disclosure may be better understood, and its numerous features and advantages made apparent to those skilled in the art by referencing the accompanying drawings.

FIG. 1 is a flow chart of a method according to at least one embodiment of the present invention.

### DETAILED DESCRIPTION

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Various embodiments of the present disclosure will now be described, by way of example only, with reference to the accompanying drawings.

Lead carbon batteries, such as those disclosed in U.S. Pat. No. 7,881,042; U.S. Pat. No. 7,998,616; U.S. Pat. No. 8,023,251; and U.S. Pat. No. 8,202,653, typically utilize a standard lead acid battery positive electrode and a supercapacitor negative electrode having activated carbon in place of a lead negative electrode.

Put differently, the active material of a lead carbon battery negative electrode includes activated carbon. Activated carbon, as used herein, refers to any predominantly carbon-based material that exhibits a surface area greater than about 100 m²/g, such as about 100 m²/g to about 2500 m²/g, as measured using conventional single-point BET techniques (for example, using equipment provided by Micromeritics FlowSorb III 2305/2310).

As stated above, the activated carbon negative electrode has a very high surface area. During charge and discharge operations, the positive electrode of the lead carbon battery undergoes the same chemical reaction that occurs in a lead acid battery. However, unlike in a lead acid battery, the negative electrode of a lead carbon battery does not undergo a chemical reaction during charge and discharge operations.

Instead, the very high surface area activated carbon negative electrode of a lead carbon battery stores protons (H⁺) from the acid in a layer on the surface of the electrode. These protons move to the positive electrode during discharge where they are neutralized to form water. This reduction in acid concentration swings from the charged to discharged state (as found in, for example, lead acid batteries) reduces grid corrosion on the positive electrode, and results in longer life and other additional benefits.

With reference to the above, the negative electrode of a lead carbon battery can constitute five layer assemblies having a first carbon electrode, a corrosion barrier, a current collector, a second corrosion barrier, and a second carbon electrode. The current collector of the negative electrode can include a material having a better conductivity than lead such as: copper, iron, titanium, silver, gold, aluminum, platinum, palladium, tin, zinc, cobalt, nickel, magnesium, molybdenum, stainless steel, alloys thereof, mixtures thereof, and/or combinations thereof.

Moreover, as stated above, a corrosion-resistant protective coating that is capable of effectively and efficiently protecting said current collector from corrosion and other detrimental forms of material degradation; and overcomes the above-described disadvantages and problems associate with the graphite foil/graphite sheet approach would be beneficial.

Accordingly, embodiments of the present invention address these and other needs by providing new and innovative materials and in particular liquid coatings and methods for protecting the current collector (e.g., copper current collector) in the negative electrode, by, inter alia, eliminating the graphite foil/graphite sheet from the negative electrode.

Specifically, embodiments of the present invention include a corrosion-resistant conductive liquid coating for a current collector (hereinafter “liquid coating”). The liquid coating of the present invention has properties of both high conductivity and resistance to corrosion. Resistance to corrosion as used herein includes resistance to acid attack or corrosion from contact with an acid or a highly acidic compound.

Liquid coatings of the present invention can include a mixture of carbon and wax. In embodiments, the mixture of carbon and wax can be heated to form liquid coatings of the present invention.

Suitable carbon for liquid coating embodiments of the present invention include any variety of conductive carbon, including but not limited to various types of graphite and carbon black, and mixtures thereof. For example, in cases where the conductive carbon is in the form of graphite, the graphite can be made from high density or low density expanded graphite particles. In certain embodiments of the present invention, the graphite can also be in the form of flake graphite.

In alternate embodiments, the conductive carbon of the liquid coating can also include carbon black in various forms, alone or in combination with graphite.

Alternatively, in cases where it is desired, the conductive carbon of the present invention can also include a conductive but corrosion-resistant material, such as titanium sub-oxide or conductive diamond materials. In certain embodiments, the titanium sub-oxide material may be TiₓO₂ₓ₋₁ (where x is an integer), for example, Ti₄O₇ or Ti₅O₉. Titanium sub-oxide is generally more conductive, thinner, and provides less electrical resistance than graphite.

In embodiments, the conductive diamond material may be a layer or film deposited by a hot filament chemical vapor deposition (CVD) method, microwave plasma CVD method, plasma arc jet method, or plasma vapor deposition (PVD) method. The conductive diamond may be doped, for example, with boron.

Suitable waxes for embodiments of the present invention include paraffin wax, microcrystalline wax, and various mixtures and combinations thereof. Examples of microcrystalline wax include microcrystalline petroleum wax.

In general, microcrystalline waxes differ from paraffin waxes in that the molecular structure of a microcrystalline wax is more branched and the hydrocarbon chains are longer, thereby resulting in a higher molecular weight. Moreover, the crystal structure of microcrystalline wax is much finer than that of a paraffin wax, and this structural different directly impacts many of the physical properties of the wax. More specifically, microcrystalline waxes are generally tougher, more flexible and generally higher in melting point than paraffin waxes. The ratio of iso-paraffinic hydrocarbons and naphthenic hydrocarbons is also higher in microcrystalline waxes as compared to paraffin waxes.

The melting point of microcrystalline waxes is higher compared to the melting point of paraffin waxes Microcrystalline waxes in embodiments of the present invention can have a melting point in a range of approximately 75 to 90° C.

Suitable microcrystalline waxes for embodiments of the present invention include both “hard” and “sticky” microcrystalline waxes. Referring to the phrase “hard microcrystalline wax”, the term “hard” used in conjunction with microcrystalline wax herein is meant to refer to microcrystalline waxes which form a hard shell upon drying. Alternatively, regarding the phrase “sticky microcrystalline wax,” the term “sticky” used in conjunction with microcrystalline wax herein is meant to refer to microcrystalline waxes which remain relatively elastic or sticky. Although referred to as “sticky,” sticky microcrystalline waxes are still very touch materials while at the same time having plastic properties. This combination makes the microcrystalline waxes ductile and flexible, while remaining a high tensile strength material.

An example of a hard microcrystalline wax is INDRAMIC 7883, a microcrystalline petroleum wax, manufactured by Industrial Raw Materials, LLC of Plainview, N.Y. An example of a sticky microcrystalline wax is MULTIWAX® 835-W microcrystalline wax, manufactured by Sonneborn Refined Products of Petrolia, Pa.

Moreover, it will be appreciated that both above-described general types of microcrystalline waxes, including mixtures and combinations thereof, are suitable and capable of forming protective coverings from material degradation for current collectors according to embodiments of the present invention.

As mixtures and combinations of waxes, it will be appreciated that any combination of one or more types of microcrystalline wax (including, inter alia, both hard and sticky microcrystalline wax), with or without one or more types of paraffin wax, can be used with regard to the present invention. In particular, mixtures and combinations of waxes can include a combination of different types of microcrystalline waxes with no paraffin wax present; and/or a combination of different types of paraffin waxes with no microcrystalline wax present; and/or combinations of at least one microcrystalline wax with at least one paraffin wax (e.g., mixtures and combinations of waxes suitable for the present invention can include one or more types of microcrystalline wax; one or more types of paraffin wax; and/or one or more types of microcrystalline wax with one or more types of paraffin wax, etc.).

Liquid coating mixtures of the present invention can also have a carbon loading in a range of approximately 10 to 50 wt. %, based on a total weight of the mixture. In certain embodiments, the carbon loading can be approximately 25 to 35 wt. %, such as 30 wt. %, based on a total weight of the mixture.

Coatings which are applied and/or made onto current collectors, using corrosion-resistant liquid coatings of the present invention, can have a thickness of approximately 0.0025 to 0.020 inches (0.0635 to 0.508 mm), such as approximately 0.0025 to 0.019 inches, approximately 0.0025 to 0.018 inches, approximately 0.0025 to 0.017 inches, approximately 0.0025 to 0.016 inches, approximately 0.0025 to 0.015 inches, approximately 0.0025 to 0.010 inches, and/or approximately 0.0025 to 0.009 inches.

Moreover, it will be appreciated that the thickness range of the coating as stated above (approximately 0.0025 to 0.020 inches) is a thickness measured from one side of the current collector to which the liquid coating was applied. Therefore, it can be said that a current collector having a liquid coating of the present invention applied thereto can result in a coating thickness of approximately 0.0025 to 0.020 inches, as measured from the surface of each side, or per side, of the current collector.

In terms of lower limits, the protective coating that is formed after the application of said coating to the current collector can have a thickness of at least approximately 0.0025 inches, such as at least approximately 0.0026 inches, at least approximately 0.0027 inches, at least approximately 0.0028 inches, at least approximately 0.0029 inches, and/or at least approximately 0.0030 inches, as measured from a surface of one side of the current collector.

In terms of upper limits, the protective coating that is formed after the application of said coating to the current collector can have a thickness of no greater than approximately 0.020 inches, such as no greater than approximately 0.019 inches, no greater than approximately 0.018 inches, no greater than approximately 0.017 inches, no greater than approximately 0.016 inches, no greater that approximately 0.015 inches, no greater than approximately 0.014 inches, no greater than approximately 0.013 inches, no greater than approximately 0.012 inches, and/or no greater than approximately 0.011 inches, as measured from a surface of one side of the current collector.

Embodiments of the present invention also include methods for protecting a current collector from material degradation. Material degradation, as used herein, includes but is not limited to metal corrosion (e.g., by coming into contact with an acid or an acidic substance).

Methods of the present invention generally include applying a liquid coating to a current collector. In terms of mechanisms for applying the liquid coating, suitable application mechanisms include but are not limited to utilizing spray methods, spin coating methodologies, and/or lowering or submerging the current collector in a liquid coating bath.

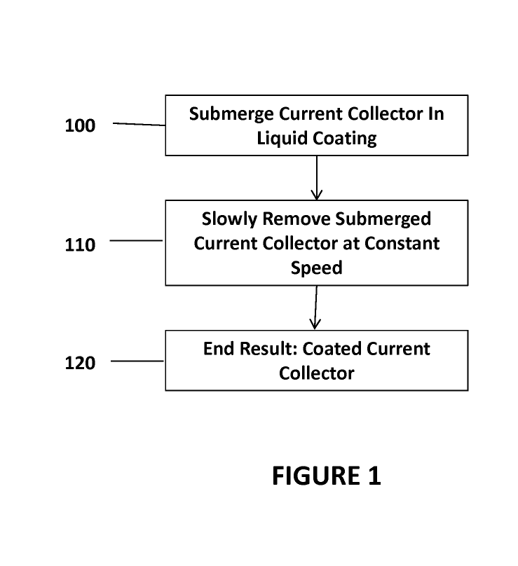

With reference to FIG. 1, methods of the present invention can include submerging a current collector in a liquid coating 100, as noted above. The liquid coating can include a mixture of carbon and wax. The method can further include slowly removing the submerged current collector at a constant removal speed from the liquid coating. It will be appreciated that during the submerging step, the entirety of the current collector is submerged into the coating bath or coating mixture for a duration of time.

The liquid coating can share features substantially similar to, and/or identical with, those described above with respect to corrosion-resistant conductive liquid coatings of the present invention. Therefore, in the interests of succinctness and improved readability, the above description with regard to liquid coatings of the present invention will not be repeated herein. Accordingly, the above description with regard to liquid coatings of the present invention (e.g., types of components, weight percent loading, melting points, etc.) equally applies to coatings relating to methods of the present invention, and is incorporated herein by reference in its entirety.

Referring back to FIG. 1, the submerging of the current collector 100 can take place for approximately 4 to 20 seconds, such as approximately 5 to 20 seconds, approximately 6 to 20 seconds, approximately 5 to 18 seconds, approximately 5 to 15 seconds, approximately 6 to 20 seconds, approximately 7 to 20 seconds, and/or approximately 8 to 20 seconds.

In terms of lower limits, the submerging of the current collector 100 can take place for at least approximately 4 seconds, such as at least approximately 5 seconds, at least approximately 6 seconds, at least approximately 7 seconds, at least approximately 8 seconds, at least approximately 9 seconds, at least approximately 10 seconds, and/or at least approximately 11 seconds.

In terms of upper limits, the submerging of the current collector 100 can take place for no greater than approximately 20 seconds, such as no greater than approximately 19 seconds, no greater than approximately 18 seconds, no greater than approximately 17 seconds, no greater than approximately 16 seconds, no greater than approximately 15 seconds, no greater than 14 seconds, no greater than approximately 13 seconds, no greater approximately 12 seconds, no greater than approximately 11 seconds, and/or no greater than approximately 10 seconds.

Referring back to FIG. 1, in certain method embodiments of the present invention, the submerged current collector can be removed from the liquid coating bath relatively slowly, at a consistent and a constant speed 110. Suitable speeds of removal include approximately 0.25 inches/second to approximately 3 inches/second, such as approximately 0.025 inches/second to approximately 2.95 inches/second, approximately 0.025 inches/second to approximately 2.90 inches/second, approximately 0.025 inches/second to approximately 2.85 inches/second, approximately 0.025 inches/second to approximately 2.80 inches/second, and/or approximately 0.025 inches/second to approximately 2.75 inches/second.

The end result of methods of the present invention is a coated current collector 120, having a coating or a protective layer that is, inter alia, corrosion-resistant and conductive and is capable of protecting the current collector from material degradation.

Current collectors typically have a square geometry with angled edges. As a result, for instances where it can be challenging to achieve complete edge coverage of the current collector as a result of the applying step; and/or in instances where additional protection from material degradation, particularly at the edges of the current collector, might be desired, methods of the present invention can also include applying a glue line around a perimeter of the current collector after the liquid coating is applied to the current collector. In embodiments, the glue line can include tar.

Moreover, it will be appreciated by one of ordinary skill that a glue line can be applied regardless of what materials constitute the liquid coating; and regardless of what mechanism was used to apply the liquid coating to the current collector (e.g., spin coating, spraying, or submerging the current collector in the liquid coating).

For example, a glue line can be applied in cases where the liquid coating includes, inter alia, flake graphite and a hard microcrystalline wax. A glue line can also be applied in cases where the liquid coating includes at least one sticky microcrystalline wax. Moreover, a glue line can be applied where the liquid coating includes at least one paraffin wax; and wherein the liquid coating includes combinations and mixtures of various waxes, as described above (e.g., one or more types of microcrystalline wax; one or more types of paraffin wax; and/or one or more types of microcrystalline wax with one or more types of paraffin wax, etc.).

Method embodiments of the present invention can also include chemically etching the edges of the current collector, in cases where additional protection from material degradation (e.g., corrosion) is desired, particularly at the current collector edges. For example, in the case of a copper current collector, copper etching can be performed.

In method embodiments of the present invention, the coated current collector (e.g., the current collector after it has been sprayed, spin coated, and/or submerged in or with the liquid coating of the present invention) can have a total thickness of approximately 30 to 45 mm (approximately 1.18 to 1.77 inches), such as approximately 31 to 45 mm, approximately 32 to 45 mm, approximately 33 to 45 mm, approximately 35 to 45 mm, approximately 30 to 44 mm, approximately 30 to 43 mm, and/or approximately 30 to 40 mm. It will be appreciated that the above thicknesses referring to the coated current collector include both the thickness of the applied protective coating from the application step and the thickness of current collector itself.

In terms of lower limits, the coated current collector can have a thickness of at least approximately 30 mm, such as at least approximately 31 mm, at least approximately 32 mm, at least approximately 33 mm, at least approximately 34 mm, at least approximately 35 mm, and/or at least approximately 36 mm.

In terms of upper limits, the coated current collector can have a thickness of no greater than approximately 45 mm, such as no greater than approximately 44 mm, no greater than approximately 43 mm, no greater than approximately 42 mm, no greater than approximately 41 mm, and/or no greater than approximately 40 mm.

Regarding the protective coating that is formed after application of the liquid coating to the current collector, the protective coating itself can have a thickness of approximately 0.0025 to 0.020 inches (0.0635 to 0.508 mm), such as approximately 0.0025 to 0.019 inches, approximately 0.0025 to 0.018 inches, approximately 0.0025 to 0.017 inches, approximately 0.0025 to 0.016 inches, approximately 0.0025 to 0.015 inches, approximately 0.0025 to 0.010 inches, and/or approximately 0.0025 to 0.009 inches.

Moreover, it will be appreciated that the thickness of the coating (approximately 0.0025 to 0.020 inches) applied to the current collector is a thickness that is measured from a surface of one side of the current collector that was subjected to an application of the liquid coating to the outer surface of the applied coating. Therefore, it can be said that a current collector post-application of a liquid coating of the present invention can result in having a coating thickness of approximately 0.0025 to 0.020 inches, as measured from the surface of each side, or per side, of the current collector.

In terms of lower limits, the protective coating that is formed after application of the liquid coating to the current collector can have a thickness of at least approximately 0.0025 inches, such as at least approximately 0.0026 inches, at least approximately 0.0027 inches, at least approximately 0.0028 inches, at least approximately 0.0029 inches, and/or at least approximately 0.0030 inches, as measured from a surface of one side of the current collector.

In terms of upper limits, the protective coating that is formed after application of the liquid coating to the current collector can have a thickness of no greater than approximately 0.020 inches, such as no greater than approximately 0.019 inches, no greater than approximately 0.018 inches, no greater than approximately 0.017 inches, no greater than approximately 0.016 inches, no greater that approximately 0.015 inches, no greater than approximately 0.014 inches, no greater than approximately 0.013 inches, no greater than approximately 0.012 inches, and/or no greater than approximately 0.011 inches, as measured from a surface of one side of the current collector.

Methods of the present invention can also include a step of electropolishing edges of the current collector to round the generally square or angular edges. The electropolishing can be performed prior to or after the application of the protective liquid coating to the current collector.

Moreover, it will be appreciated by one of ordinary skill in the art that although embodiments of the present invention have been described herein primarily with regard to lead carbon batteries, the above description of embodiments of the present invention in conjunction with lead carbon batteries is not intended to be limiting. Specifically, liquid coatings, materials, and/or methods of the present invention can be utilized in conjunction with current collectors that can be present in other battery types (e.g., lead acid batteries). As a result, corresponding embodiments with regard to different types of batteries are intended to be within the scope of this invention.

Embodiments of the present invention provide innovative and novel materials, liquid coatings and methods for protecting current collectors from material degradation. It was discovered that embodiments of the present invention: (1) result in improved resistance of electrode cells; (2) provide a reduction in the thickness of the electrode; (3) generate significant cost savings; and (4) yield increased energy output, among other unexpected advantages and results.

More specifically, by eliminating the traditional graphite foil/graphite sheet current collector apparatus with embodiments of the present invention, the thickness of the electrode is reduced by approximately half. In some instances, approximately 2.5 mm of space is now freed up per cell. This freed up space provides opportunity for flexibility in electrode design as increased carbon (e.g., the case of lead carbon batteries), absorbent glass mat (AGM), and/or plate counts are possible. If the space is used exclusively for added carbon (e.g., in the case of lead carbon batteries), a 10-15% or greater increase in energy output can result.

The corresponding structures, materials, acts, and equivalents of all means plus function elements in the claims below are intended to include any structure, or material, for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

It will be appreciated that not all of the features, components and/or activities described above in the general detailed description in relation to embodiments of the present disclosure or the examples are required, that a portion of a specific feature, component and/or activity may not be required, and that one or more further features, components and/or activities may be required, added or performed in addition to those described. Still further, the orders in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention.

Further, references to values stated in ranges include each and every value within that range, and the endpoints of said ranges. Thus, to the maximum extent allowed by law, the scope of the present invention is to be determined by the broadest permissible interpretation of the following claims and their equivalents, and shall not be restricted or limited by the foregoing detailed description.

What is claimed is:

1. A corrosion-resistant conductive liquid coating for a current collector comprising a mixture of carbon and wax,
wherein the wax is selected from the group consisting of a paraffin wax, a microcrystalline wax, and mixtures and combinations thereof, and
wherein the mixture of carbon and wax has a carbon loading in a range of approximately 10 to 50 wt. % based on a total weight of the mixture.

2. The corrosion-resistant conductive liquid coating of claim 1, wherein the carbon loading is approximately 25 to 35 wt. % based on a total weight of the mixture.

3. The corrosion-resistant conductive liquid coating of claim 1, wherein the carbon is selected from the group consisting of high density expanded graphite, low density expanded graphite, and carbon black.

4. The corrosion-resistant conductive liquid coating of claim 1, wherein the wax is a microcrystalline wax having a melting point of approximately 75 to 90 degrees Celsius.

5. The corrosion-resistant conductive liquid coating of claim 1, wherein the wax includes at least one member selected from the group consisting of a hard microcrystalline wax and a sticky microcrystalline wax.

6. The corrosion-resistant liquid coating of claim 1, wherein the coating has a thickness of approximately 0.0025 to 0.020 inches (0.0635 to 0.508 mm), measured from a surface of one side of the current collector.

7. A lead carbon battery comprising the corrosion-resistant conductive liquid coating of claim 1.

8. A method for protecting a current collector from material degradation, the method comprising:
applying a liquid coating comprising a mixture of carbon and wax onto an outer surface of the current collector, thereby providing a coated current collector,
wherein the wax is selected from the group consisting of a paraffin wax, a microcrystalline wax, and mixtures and combinations thereof, and
wherein the mixture of carbon and wax has a carbon loading in a range of approximately 10 to 50 wt. % based on a total weight of the mixture.

9. The method of claim 8, wherein the applying comprises:
submerging the current collector in a liquid coating; and
removing the submerged current collector at a constant removal speed from the liquid coating mixture.

10. The method of claim 8, wherein the applying comprises spin coating the liquid coating onto the current collector.

11. The method of claim 8, wherein the applying comprises spraying the liquid coating onto the current collector.

12. The method of claim 8, further comprising applying a glue line around a perimeter of the current collector after applying the liquid coating, the glue line comprising tar.

13. The method of claim 8, wherein the wax includes at least one member selected from the group consisting of a hard microcrystalline wax and a sticky microcrystalline wax.

14. The method of claim 8, wherein the wax is a microcrystalline wax having a melting point of approximately 75 to 90 degrees Celsius.

15. The method of claim 8, wherein the carbon is selected from the group consisting of high density expanded graphite, low density expanded graphite, and carbon black.

16. The method of claim 8, wherein the carbon loading is approximately 25 to 35 wt. % based on a total weight of the mixture.

17. The method of claim 8, wherein the coated current collector has a thickness of approximately 1.18 to 1.77 inches (30 to 45 mm).

18. The method of claim 8, wherein the coating on the coated current collector has a thickness of approximately 0.0025 to 0.020 inches (0.0635 to 0.508 mm), as measured from a surface of one side of the coated current collector.

19. The method of claim 8, further comprising electropolishing edges of the current collector to produce substantially rounded edges.

20. The method of claim 8, further comprising chemically etching edges of the current collector prior to applying the liquid coating.
